(19) United States
(12) Patent Application Publication
(10) Pub. No.: US 2010/0271637 A1
(43) Pub. Date: Oct. 28, 2010

(54) THEODOLITE WITH LASER INDICATORS

(76) Inventor: Nen-Tsua Li, Taichung (TW)

Correspondence Address: Hershkovitz & Associates, LLC, 2845 Duke Street, Alexandria, VA, 22314, US

(21) Appl. No.: 12/428,671

(22) Filed: Apr. 23, 2009

(51) Int. Cl. G01B 11/14

(52) U.S. Cl. 356/614

(57) ABSTRACT

A theodolite with laser indicators has a seat, a body, a rotating case and two laser indicators. The seat can be set on a tripod and has an adjustable level base. The level base can be adjusted to a virtual level. The body is rotatably mounted on the level base and has a frame and two arms. The frame has a top. The two arms respectively extend from the top of the frame. The rotating case is rotatably mounted between the two arms of the body and has a top and a bottom. The laser indicators are respectively mounted rotatably on the top and bottom of the rotating case and generate horizontal and vertical laser beams to indicate a predicted position for improved measuring accuracy.

### BACKGROUND OF THE INVENTION

1. Field of the Invention

The present invention relates to a theodolite, and more particularly to a theodolite with laser indicators generating laser beams to indicate a predicted position for improved measuring accuracy.

2. Description of Related Art

A conventional theodolite has a base, a body and three laser indicators. The body is fixed on the base and has three orthogonal surfaces. The three laser indicators are respectively, rotatably mounted on the three orthogonal surfaces of the body. The three laser indicators respectively generate three orthogonal laser beams to indicate X-, Y- and Z-axes to improve 3-D measuring and precisely display a predicted position.

However, the body is fixed on the base and cannot be rotated. Therefore, laser beams from the three laser indicators only can be adjusted one by one and cannot be directly rotated on the body to adjust an indicating angle. Furthermore, the conventional theodolite has three laser indicators, which are difficult to simultaneously calibrate.

To overcome the shortcomings, the present invention tends to provide a theodolite with laser indicators having a rotatably body to mitigate or obviate the aforementioned problems.

### SUMMARY OF THE INVENTION

The main objective of the invention is to provide a theodolite with laser indicators generating laser beams to indicate a predicted position for improved measuring accuracy.

The theodolite with laser indicators comprising a seat, a body, a rotating case, a horizontal laser indicator and a vertical laser indicator. The seat can be set on a tripod and has a level base. The level base is adjustable and can be adjusted to a virtual level. The body is rotatably mounted on the level base and has a frame and two arms. The frame has a top. The two arms respectively extend from the top of the frame. The rotating case is rotatably mounted between the two arms of the body and has a top and a bottom. The horizontal laser indicator is rotatably mounted on the top of the rotating case and generates a horizontal laser beam. The vertical laser indicator is rotatably mounted on the bottom of the rotating case and generates a vertical laser beam. The horizontal and vertical laser indicators indicate a predicted position for improved measuring accuracy.

Other objects, advantages and novel features of the invention will become more apparent from the following detailed description when taken in conjunction with the accompanying drawings.

### BRIEF DESCRIPTION OF THE DRAWINGS

FIG. 1 is a front perspective view of a theodolite with laser indicators in accordance with the present invention;

FIG. 2 is a rear perspective view of the theodolite with laser indicators in FIG. 1;

FIG. 3 is a front view of the theodolite with laser indicators in FIG. 1;

FIG. 4 is an operational top view of the theodolite with laser indicators in FIG. 1;

FIG. 5 is an operational perspective view of the theodolite with laser indicators in FIG. 1; and

FIG. 6 is an operational perspective view of the theodolite with laser indicators in FIG. 5, the laser indicators being adjusted.

### DETAILED DESCRIPTION OF PREFERRED EMBODIMENT

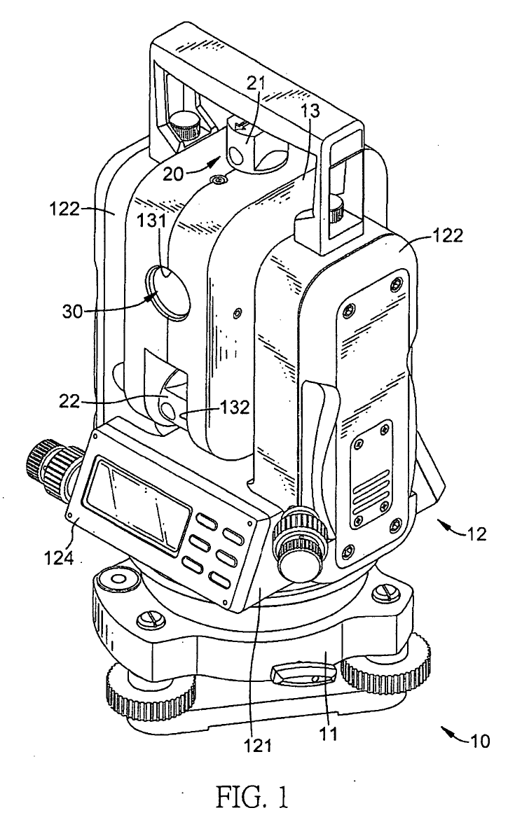

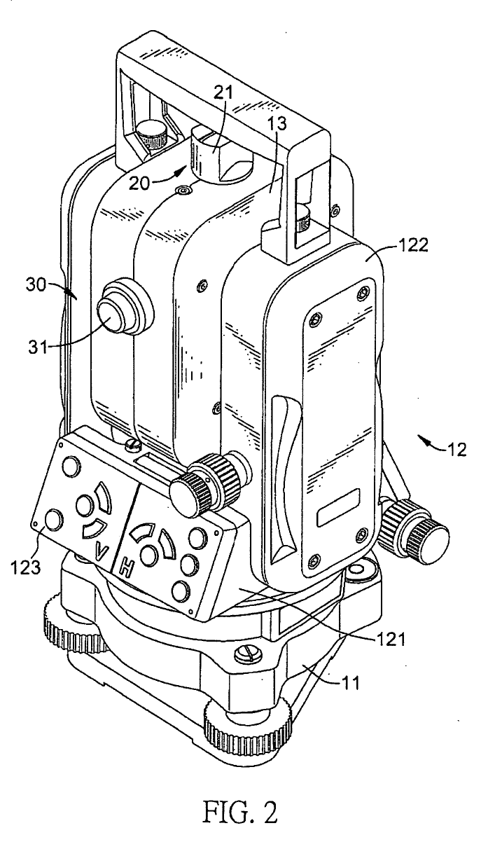

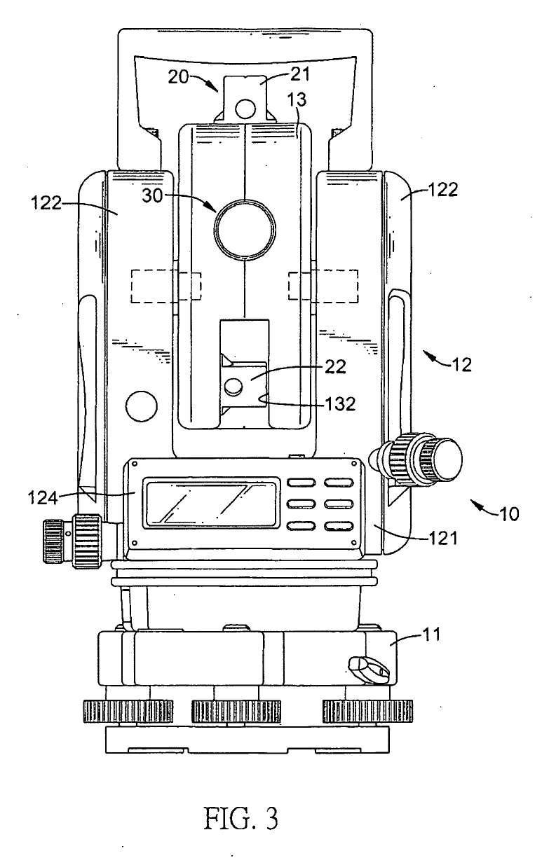

With reference to FIGS. 1 to 3, a theodolite with laser indicators in accordance with the present invention comprises a seat (10), a body (12), a rotating case (13), two laser indicators (20) and a telescope (30).

The seat (10) has a bottom, three adjusting knobs and a level base (11). The bottom of the seat (10) may be set on a tripod. The three adjusting knobs are rotatably mounted on the bottom. The level base (11) is adjustable and is adjustably mounted on the three adjusting knobs and can be adjusted to a virtual level by the three adjusting knobs.

The body (12) is rotatably mounted on the level base (11) and has a frame (121), two arms (122), a laser controller (123) and a theodolite controller (124). The frame (121) is rotatably mounted on the level base (11) and has a top, a front surface and a rear surface. The two arms (122) respectively extend from the top of the frame (121). The laser controller (123) is mounted on the rear surface of the frame (121) and can control the laser indicators (20). The theodolite controller (124) is mounted on the front surface of the frame (121) and can control the theodolite.

The rotating case (13) is rotatably mounted between the arms (21, 22) and can be turned to adjust a locating angle, and has perpendicular planes, and may has a front, a rear, a top, a bottom, a through hole (131) and a laser recess (132). The front and the rear of the rotating case (13) are perpendicularly defined between the top and the bottom of the rotating case (13). The through hole (131) is formed through the front and the rear of the rotating case (13), and may be a circular hole.

The laser recess (132) is formed in the bottom of the rotating case (13) adjacent to the front and has a side wall and a slot. The side wall is perpendicular to the front of the rotating case (13). The slot is formed in the front of the rotating case (13) and communicates with laser recess (132).

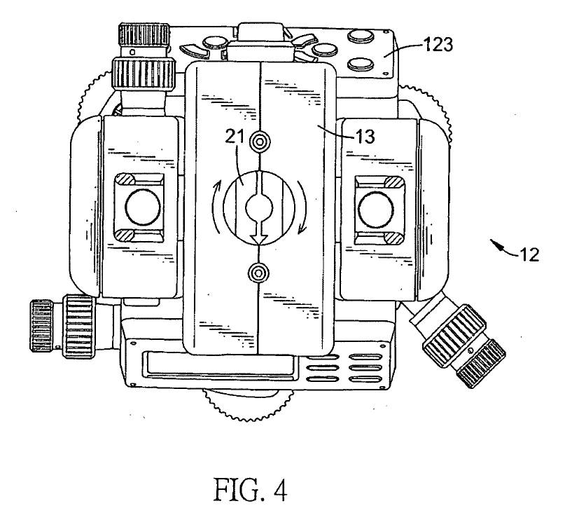

With further reference to FIG. 4, two laser indicators (20) relatively mounted at perpendicular planes and being rotatably mounted on the bottom of the rotating case (13) and respectively generating horizontal and vertical laser beams. The laser indicators (20) are a horizontal laser indicator (21) and a vertical laser indicator (22). The horizontal laser indicator (21) is rotatably mounted on the top of the rotating case (13), generates a horizontal laser beam and can be turned to adjust a horizontal indicating angle of the horizontal laser beam. The vertical laser indicator (22) is rotatably mounted on the bottom of the rotating case, may be in the side wall of the laser recess (132), generates a vertical laser beam, which may pass through the slot of the laser recess (132), and the vertical laser indicator can be turned to adjust a vertical indicating angle of the vertical laser beam.

The telescope (30) is mounted in the through hole (131) of the rotating case (13) and has an eyepiece (31). The eyepiece (31) is mounted on the rear of the rotating case (13).

In use, the two laser indicators (20) can are used and adjusted independently or simultaneously as is well known in the art.

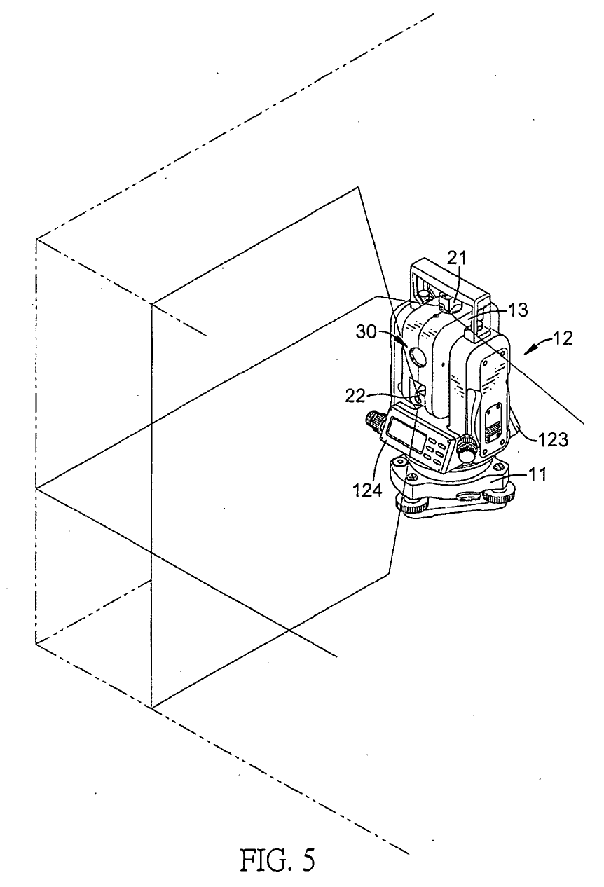

With further reference to FIG. 5, in independent use, the horizontal laser indicator (21) generates the horizontal laser beam to measure the gradient or indicate the horizontal predicted position. The vertical laser indicator (22) generates the vertical laser beam to indicate the vertical predicted position and can be controlled by the laser controller (123) to change a vertical indicating angle and mark the predicted position.

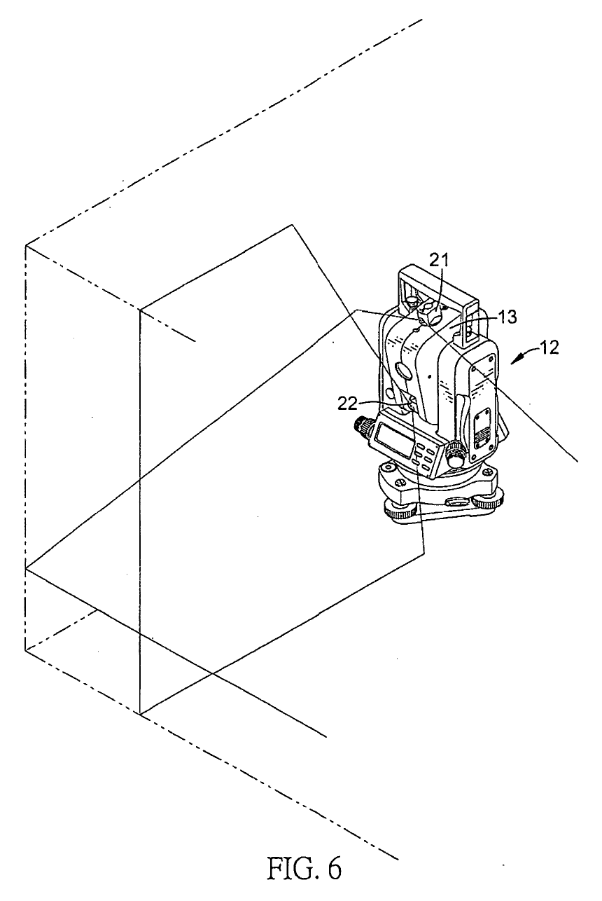

With reference to FIG. 6, in simultaneous use, the horizontal laser indicator (21) and the vertical laser indicator (22) respectively generate horizontal and vertical laser beams and display cross lines on the wall or the like to improve measuring accuracy. In addition, the rotating case (13) is able to be turned to adjust the locating angle and make the laser beams from the laser indicators (20) cross at different position on the wall or the like to provide a convenient application.

Furthermore, the theodolite also has the telescope (30) being controlled by the theodolite controller (124) to make a transit survey and provide a multi-use theodolite.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A theodolite with laser indicators comprising:
a seat having a level base being adjustably to a virtual level;
a body having
a frame being rotatably mounted on the level base and having a top; and
two arms respectively extending from the top of the frame;
a rotating case being rotatably mounted between the arms of the body and having
two perpendicular planes;
two laser indicators being a horizontal laser indicator and a vertical laser indicator and relatively mounted at the perpendicular planes of the rotating case and being rotatably mounted on the rotating case and respectively generating horizontal and vertical laser beams and being turned to adjust indication angles of the horizontal and vertical laser beam.

2. The theodolite with laser indicators as claimed in claim 1, wherein the rotating case further has
a top, wherein
the horizontal laser indicator is rotatably mounted on the top of the rotating case;
a bottom;
a front being perpendicularly defined between the top and the bottom of the rotating case;
a laser recess being formed in the bottom of the rotating case adjacent to the front, and having
a side wall being perpendicular to the front of the rotating case; and
a slot being formed in the front of the rotating case and communicating with the recess of the laser recess; wherein
the vertical laser indicator is rotatably mounted in the side wall of the laser recess; and
the vertical laser beam passes through the slot of the laser recess.

3. The theodolite with laser indicators as claimed in claim 1, wherein the rotating case further has
a rear being perpendicularly defined between the top and the bottom of the rotating case; and
a through hole being formed through the front and the rear of the rotating case; and
the theodolite further comprises a telescope being mounted in the through hole of the rotating case and having an eyepiece being mounted on the rear of the rotating case.

4. The theodolite with laser indicators as claimed in claim 2, wherein the rotating case further has
a rear being perpendicularly defined between the top and the bottom of the rotating case; and
a through hole being formed through the front and the rear of the rotating case; and
the theodolite further comprises a telescope being mounted in the through hole of the rotating case and having an eyepiece being mounted on the rear of the rotating case.

5. The theodolite with laser indicators as claimed in claim 1, wherein the frame further has
a front surface; and
a rear surface; and
a laser controller being mounted on the rear surface of the frame; and
a theodolite controller being mounted on the front surface of the frame.

6. The theodolite with laser indicators as claimed in claim 4, wherein the frame further has
a front surface; and
a rear surface; and
the body further has
a laser controller being mounted on the front surface of the frame; and
a theodolite controller being mounted on the rear surface of the frame.
